(19) United States
(12) Patent Application Publication
(10) Pub. No.: US 2007/0138256 A1
(43) Pub. Date: Jun. 21, 2007

(54) Enhanced accessibility of self-service terminals

(75) Inventor: Lynne Coventry, Edinburgh (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/305,759

(22) Filed: Dec. 16, 2005

(51) Int. Cl. G07F 19/00; G06F 7/08

(52) U.S. Cl. 235/379; 235/381

(57) ABSTRACT

The invention provides methods and apparatus for providing enhanced accessibility to a self-service terminal. The self-service terminal comprises a media entry/exit device and a sensor, associated with the media entry/exit device, for detecting a user's body part in close proximity to the media entry/exit device.

### TECHNICAL FIELD

The present invention relates to methods and apparatus for enhanced accessibility of self-service terminals. It is particularly related to, but in no way limited to, interactive prompts for self-service terminals (SSTs) such as automated teller machines (ATMs).

### BACKGROUND

Self-service terminals (SSTs), such as automated teller machines (ATMs) are commonly used to carry out everyday transactions which do not require human supervision. Such transactions include banking transactions (e.g. withdrawals, deposits, balance checks, statement requests etc) and ticket purchases (e.g. train or cinema tickets).

To use a conventional ATM for a banking transaction, a user is required to insert a magnetic strip card into a card reader slot in the ATM fascia. The user then must confirm their identity by entering a personal identification number (PIN) associated with the card but known only to the user. The PIN is entered via a keypad incorporated in the ATM. Once the identity of a user has been confirmed, the user is shown a number of options on the display of the ATM, which they can select by pressing buttons. The subsequent operation of the ATM depends on the option selected. If for example, the user requests a cash withdrawal, they may be presented with further options regarding the amount of cash to be withdrawn and funds permitting, the ATM may then dispense the requested amount of money from a cash dispensing slot and a receipt from a receipt printer, the cash dispensing slot and the receipt printer being incorporated into the ATM fascia. If the user has completed all the required transactions, the ATM then ejects the card from the card reader slot so that it can be retrieved by the user.

As can be appreciated from the above description, the use of an ATM by a blind or visually impaired user is difficult. Various measures have therefore been implemented to assist a visually impaired user and these may include use of Braille on the keys of the keypad or adoption of a well-known keypad orientation and standard set of raised tactile features on the keys (e.g. a raised dot on the ‘5’ key, as also used on many telephone keypads). Some ATMs are also equipped with a socket (also referred to as a jack) for an audio lead, so that when a corresponding plug is inserted into the socket (e.g. connected to an earpiece or headphones), the user is played an audio leadthrough. This audio leadthrough describes the location of the devices on the ATM (e.g. the keypad, cash dispensing slot etc) to the user.

Problems arise, however, with such ATMs. Firstly, the audio leadthrough is necessarily quite a long description of all the features and their location on the ATM. This makes it hard for the user to remember all the details and recall them quickly at a later stage when they require them. This is time consuming for the user, does not follow how they would naturally browse the ATM, and is often ignored by a user. Instead the user often relies on navigating an ATM by touch and a user may even limit themselves to using a single machine which they have successfully used in the past. This becomes more problematic with new generations of ATMs where many of the dispensing slots appear identical to the user and cannot be differentiated by touch. A second problem is that for security reasons, some functions of the ATM have a limited activation period, for example, the shutter on the cash dispensing slot is only open for a short period of time and if the money has not been retrieved at the end of the activation period, it is retracted back into the ATM. This can result in user frustration, because if they do not find a device within the required period, the operation fails and in some cases also results in user injury, when the shutter closes pinching the user's fingers.

The invention seeks to provide a self-service terminal with enhanced accessibility and an improved experience for a visually impaired user using such a self-service terminal.

### SUMMARY

A first aspect provides a self-service terminal comprising a media entry/exit device;

and a sensor, associated with the media entry/exit device, for detecting a user's body part in close proximity to the media entry/exit device.

Advantageously, this enables the self-service terminal to offer a more interactive experience which enhances the accessibility of the terminal to a visually impaired user.

Preferably the self-service terminal comprises a plurality of media entry/exit devices and a plurality of sensors, each of the plurality of sensors being associated with one of the plurality of media entry/exit devices.

Preferably the self-service terminal further comprises an interactive audio prompt system responsive to the sensor, the prompt system being arranged to provide prompts to the user of the self-service terminal.

Advantageously, this provides a user with audible feedback of where their hand is in relation to parts of the self-service terminal.

Further advantageously, this enhances the user experience for a visually impaired user and reduces the likelihood that an operation fails because the user is unable to complete a required step in the allotted time.

Preferably the interactive audio prompt system is arranged to identify the associated media entry/exit device in response to a sensor detecting the close proximity of a user's body part.

Preferably the interactive audio prompt system is arranged to provide the user with an instruction to move their body part in response to a sensor detecting the close proximity of the user's body part.

Preferably the instruction comprises a warning message.

Advantageously, this reduces the likelihood of the user being injured by moving parts.

Preferably the self-service terminal further comprises means for controlling the media entry/exit device responsive to the sensor associated with the media entry/exit device.

Preferably the means for controlling the media entry/exit device is arranged to activate the media entry/exit device responsive to detection of a user's body part in close proximity.

Preferably the means for controlling the media entry/exit device is arranged to start a timer responsive to detection of a user's body part in close proximity.

Advantageously this reduces the likelihood that an operation fails because the user is unable to complete a required step in the allotted time.

Preferably the means for controlling the media entry/exit device is arranged to deactivate the media entry/exit device responsive to the sensor associated with the media entry/exit device.

Preferably the self-service terminal further comprises means for recording sensor information.

Preferably the self-service terminal further comprises means for analyzing sensor information.

Preferably the self-service terminal further comprises fraud detection means.

Preferably the media entry/exit device comprises one of a cash dispenser, a card reader, a receipt printer, a statement printer, a deposit mechanism, a passbook reader, a money order printer, a ticket dispenser and a card dispenser.

Preferably the sensor is one of a capacitive sensor and an infra-red sensor.

A second aspect provides a method of operating a self-service terminal comprising the steps of: receiving sensor information indicating the presence of a user's body part in close proximity to a media entry/exit device; and controlling an operation of the self-service terminal responsive to the sensor information.

Preferably the step of controlling comprises activating an interactive audio prompt responsive to the sensor information.

Preferably the step of controlling comprises controlling the media entry/exit device responsive to the sensor information.

Preferably the step of controlling comprises: analyzing the sensor information to detect an indication of fraudulent activities; and providing an alert of an indication of fraudulent activities.

A third aspect provides a self-service terminal substantially as described with reference to FIG. 1 of the drawings.

The method may be performed by firmware or software in machine readable form on a storage medium.

This acknowledges that firmware and software can be valuable, separately tradable commodities. It is intended to encompass software, which runs on or controls “dumb” or standard hardware, to carry out the desired functions. For similar reasons, it is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of the front panel of a self-service terminal; and

FIGS. 2-4 show example flow diagrams of methods of operation of the self-service terminal shown in FIG. 1.

Common reference numerals are used throughout the figures to indicate similar features.

### DETAILED DESCRIPTION

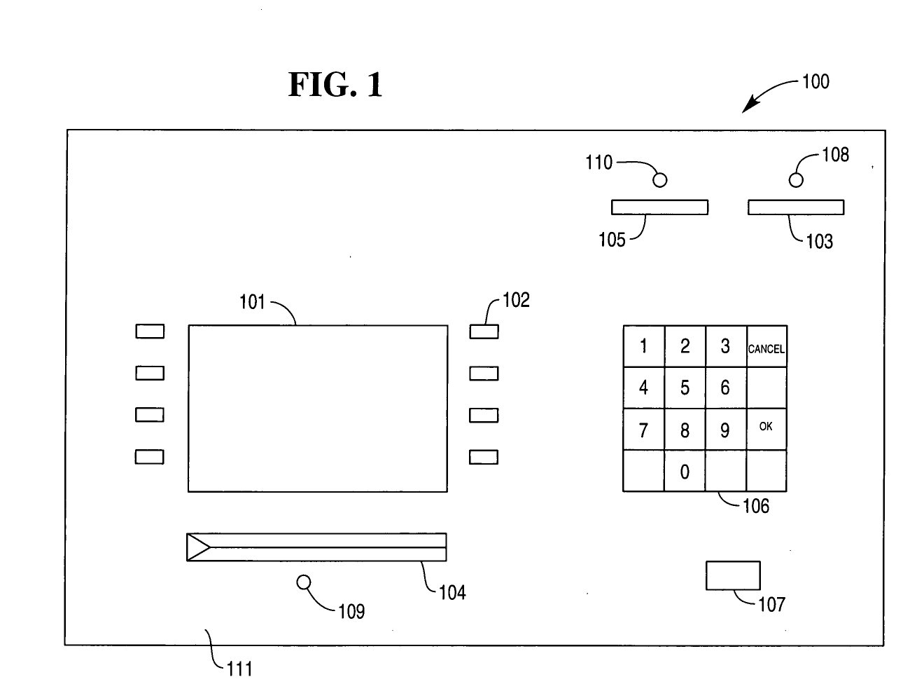

Embodiments of the present invention are described below by way of example only. These examples represent the best ways of putting the invention into practice that are currently known to the Applicant although they are not the only ways in which this could be achieved. FIG. 1 shows a schematic diagram of the front panel of a self-service terminal (SST) in the form of an automated teller machine (ATM). The ATM 100 comprises a display 101 with a number of buttons 102 arranged along the two vertical sides of the display, a card reader slot 103, a cash dispensing slot 104, a receipt printer 105, a keypad 106 and an audio socket 107. The ATM also comprises one or more proximity sensors 108-110 which may be mounted behind the fascia 111 and hence not be visible to the user. The proximity sensors are arranged such that they can detect a user's hand in close proximity to one of the media entry/exit devices, such as the card reader slot 103 (sensor 108), the cash dispensing slot 104 (sensor 109) and the receipt printer 105 (sensor 110).

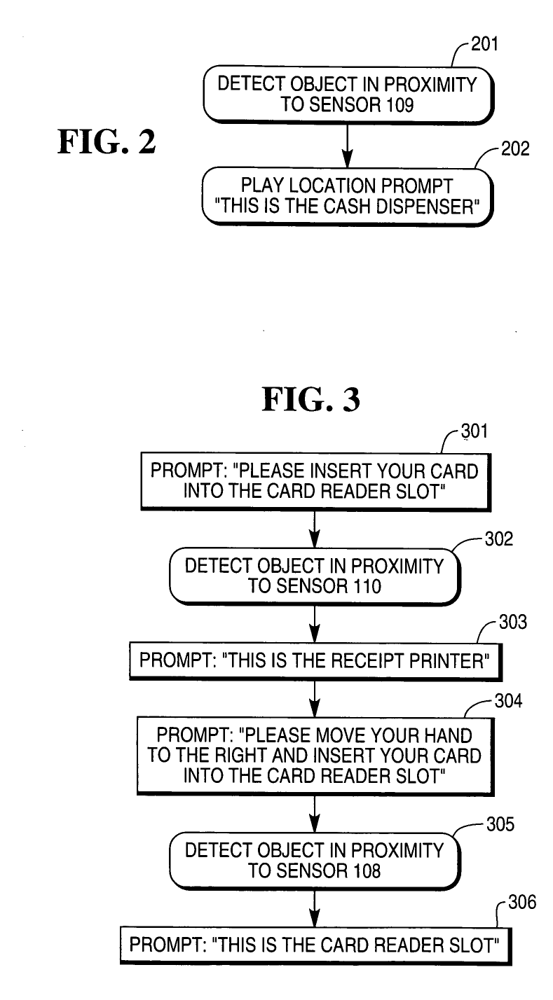

When a user inserts an audio plug into the audio socket 107, they are provided with audio prompts to assist with their use of the ATM. The audio prompts are interactive and are responsive to detection by the sensors of the position of the user's hand, although the prompts may also include some standard non-interactive explanation of the ATM, guidance for using the ATM and feedback on keypad entries. For example, as shown in the flow diagram of FIG. 2, when a user's hand hovers near a media entry/exit device (step 201), the prompt identifies the relevant part of the ATM (step 202), e.g. “This is the cash dispenser.” The interactive audio prompts therefore allow a user to quickly explore the layout of the ATM by passing their hand in front of the machine. The prompts, in response to the sensors' detection of hand position, indicate when the user's hand passes near any of the media entry/exit devices. The interactive prompts can also provide specific prompts during a transaction, for example as shown in the flow chart of FIG. 3, if the user needs to insert their card into the card reader slot 103 (step 301), but their hand is too far to the left, in the vicinity of the receipt printer 105, this will be detected by sensor 110 (step 302). The prompt can then inform the user that “this is the receipt printer” (step 303) and request that they “please move your hand to the right and insert your card into the card reader slot” (step 304). If the user then moves their hand to the right, it will be detected by sensor 108 (step 305) and the location of the hand can be confirmed by the prompt (step 306).

The interactive prompts can also be used to provide status information, feedback on user actions and warning messages, in addition to the informative messages described above. Status information may include prompts such as “your money has been dispensed; please take it within the next 15 seconds” and feedback information may include prompts such as “thank you for depositing a cheque”. Warning messages may be used, for example, if the user's hand is detected to be close to the cash dispensing slot 104 when the shutter is about to close, a warning could be given: “Shutter is about to close, please withdraw your hand.”

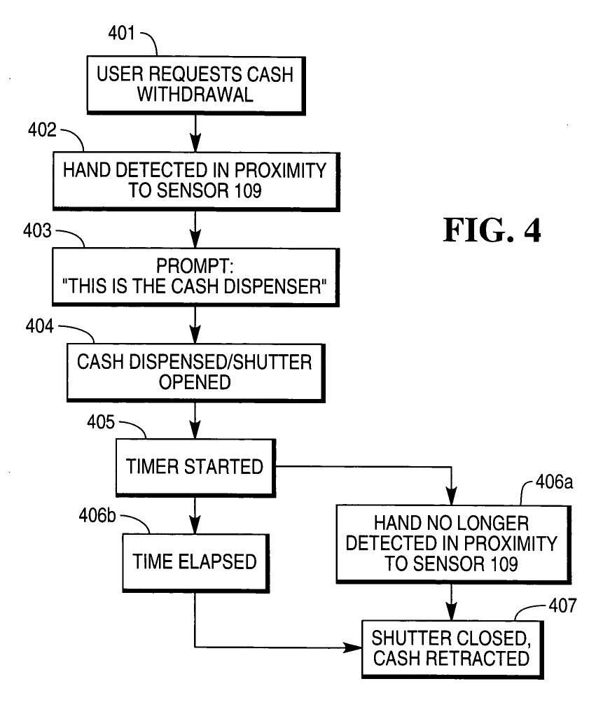

In addition to using the sensor information to drive interactive prompts, the sensor information can also be used to control some aspects of the operation of the ATM. As discussed earlier, for security reasons it is important that the cash dispensing slot remains open for only a short period of time. At the end of this period, a shutter over the cash dispensing slot (not shown in FIG. 1) may be closed and if not retrieved, any money dispensed may be retracted into the ATM. The sensor information from the sensor 109 associated with the cash dispenser slot 104 can therefore be used to trigger the dispensing of money and the start of the timer which controls the opening of the cash dispensing slot, as described with reference to FIG. 4.

A user requests a cash withdrawal (step 401) and is instructed by a prompt to take the money from the cash dispensing slot 104. The proximity sensor 109 associated with the cash dispensing slot 104 senses when the user moves their hand close to the cash dispensing slot (step 402) and the user is informed by the prompt that their hand is in the correct position (step 403). The sensor information triggers the dispensing of the requested money (step 404) and at this time a timer is started (step 405). The shutter is closed, and/or the money retracted if not collected (step 407) either when the sensor information indicates that the user has moved their hand away from the cash dispensing slot (step 406a) or when the time period elapses (step 406b).

In a similar manner, the sensor information from the sensors associated with the receipt printer 105 (sensor 110) and the card reader slot 103 (sensor 108) can be used to trigger the dispensing of receipts and the return of cards respectively.

Triggering the dispensing of media on the basis of sensor information has an advantage that the user is less likely to accidentally knock the media out of the media exit/entry device whilst trying to locate the device by touch, which may result in the user being unable to find the media.

In the above description, three media entry/exit devices were described by way of example only. Other media entry/exit devices, near which proximity sensors could be placed, include statement printers, deposit slots (for depositing cash, cheques and/envelopes), passbook readers and money order (or cheque) printers.

In addition or instead of using the proximity sensors to provide interactive prompts and/or control the operation of media entry/exit devices, the sensor information may also be used in fraud detection.

As described above, a short period after money has been dispensed, this money is retracted into the ATM if it has not been retrieved by the user. When this occurs, the amount of money withdrawn is automatically credited back to the user's account. On some occasions, it is subsequently determined that not all the money was retracted into the ATM, i.e. one or more notes, but not the entire bundle, were taken by the user. By logging sensor information relating to hand motion in the vicinity of the cash dispensing slot 104, (as sensed by sensor 109), the sensor information can be correlated with such occurrences of missing notes. This may enable instances of fraud to be identified and distinguished from situations where an incorrect amount was dispensed.

In another example, patterns of transient sensor information can be identified from the sensor information which may indicate that a fraud is going to occur. For example, a user spending too much time handling an ATM may be preparing to attach a card reading device or a key logging device to the ATM. If such patterns can be detected at an early stage, there is a chance that the person committing the fraud can be caught in the act and/or before they have obtained personal information from other users. Machine learning techniques and pattern detection algorithms may be used to analyze the sensor information and improve detection of fraudulent activities. An alert may be triggered when suspicious patterns of transient behavior are identified. The alert may be provided to the operator of the SST and may also cause the SST to stop functioning or change its mode of operation (e.g. to one where no further media is dispensed).

The sensors may be capacitive sensors, infra-red sensors, motion sensors or any other type of sensor capable of detecting the proximity of a user's hand to a particular feature of a SST. The sensors are shown in FIG. 1 as being discrete sensors located close to each media entry/exit device, however, the sensors could alternatively be arranged in a grid over some or all of the fascia of the SST.

The proximity sensors used to control the interactive prompts and operation of the ATM may be combined with existing proximity sensors in the ATM which are used for fraud detection, as described in U.S. Pat. No. 6,390,367, by detecting foreign objects fixed to the front of the ATM.

Although the above description refers to detection of a user's hand, the sensors may detect any part of the user's body in close proximity.

Although in the above description, the ATM is described as having an audio socket. It will be apparent to those skilled in the art that a user may connect to the ATM using wireless technologies such as Infra-Red, Bluetooth etc. In another example, where the SST is provided in a kiosk or other private area, the audio prompts may be provided through a speaker. The audio prompts may be triggered by a connection being made to the audio socket or in another example, information encoded on the magnetic strip of the user's card may trigger the audio prompts.

Although the above description relates to an ATM, this is by way of example only. The invention is applicable to any self-service terminal including, but not limited to, banking machines, ticket machines, public telephones and vending machines and voting machines. The media handled by the media entry/exit device may include plastic cards (e.g. credit, debit cards), currency, receipts, statements, tickets, ballot papers, other printed matter, phone top-up cards etc.

Any range or device value given herein may be extended or altered without losing the effect sought, as will be apparent to the skilled person.

The steps of the methods described herein may be carried out in any suitable order, or simultaneously where appropriate.

It will be understood that the above description of a preferred embodiment is given by way of example only and that various modifications may be made by those skilled in the art.

What is claimed is:

1. A self-service terminal comprising:
a media entry/exit device; and
a sensor, associated with the media entry/exit device, for detecting a user's body part in close proximity to the media entry/exit device.

2. A self-service terminal according to claim 1, comprising a plurality of media entry/exit devices and a plurality of sensors, each of the plurality of sensors being associated with one of the plurality of media entry/exit devices.

3. A self-service terminal according to claim 1, further comprising an interactive audio prompt system responsive to the sensor, the prompt system being arranged to provide prompts to the user of the self-service terminal.

4. A self-service terminal according to claim 3, wherein the interactive audio prompt system is arranged to identify the associated media entry/exit device in response to a sensor detecting the close proximity of a user's body part.

5. A self-service terminal according to claim 3, wherein the interactive audio prompt system is arranged to provide the user with an instruction to move their body part in response to a sensor detecting the close proximity of the user's body part.

6. A self-service terminal according to claim 5, wherein the instruction comprises a warning message.

7. A self-service terminal according to claim 1, further comprising means for controlling the media entry/exit device responsive to the sensor associated with the media entry/exit device.

8. A self-service terminal according to claim 7, wherein the means for controlling the media entry/exit device is arranged to activate the media entry/exit device responsive to detection of a user's body part in close proximity.

9. A self-service terminal according to claim 7, wherein the means for controlling the media entry/exit device is arranged to start a timer responsive to detection of a user's body part in close proximity.

10. A self-service terminal according to claim 7, wherein the means for controlling the media entry/exit device is arranged to deactivate the media entry/exit device responsive to the sensor associated with the media entry/exit device.

11. A self-service terminal according to claim 1, further comprising means for recording sensor information.

12. A self-service terminal according to claim 1, further comprising means for analyzing sensor information.

13. A self-service terminal according to claim 1, further comprising fraud detection means.

14. A self-service terminal according to claim 1, wherein the media entry/exit device comprises one of a cash dispenser, a card reader, a receipt printer, a statement printer, a deposit mechanism, a passbook reader, a money order printer, a ticket dispenser and a card dispenser.

15. A self-service terminal according to claim 1, wherein the sensor is one of a capacitive sensor and an infra-red sensor.

16. A method of operating a self-service terminal comprising the steps of:
receiving sensor information indicating the presence of a user's body part in close proximity to a media entry/exit device; and
controlling an operation of the self-service terminal responsive to the sensor information.

17. A method according to claim 16, wherein the step of controlling comprises:
activating an interactive audio prompt responsive to the sensor information.

18. A method according to claim 16, wherein the step of controlling comprises:
controlling the media entry/exit device responsive to the sensor information.

19. A method according to claim 16, wherein the step of controlling comprises:
analyzing the sensor information to detect an indication of fraudulent activities; and
providing an alert of an indication of fraudulent activities.
